(19) United States
(12) Patent Application Publication
(10) Pub. No.: US 2025/0189142 A1
(43) Pub. Date: Jun. 12, 2025

(54) SYSTEMS AND METHODS FOR WASTEWATER HEAT RECOVERY

(71) Applicant: EPIC CLEANTEC INC., San Francisco, CA (US)

(72) Inventors: Aaron Tartakovsky, San Francisco, CA (US); Igor Tartakovsky, San Francisco, CA (US); Megan Thomas, Austin, TX (US); Eric Hough, San Diego, CA (US); Richard Ross, Las Vegas, NV (US); Lauren Frazier, Oakland, CA (US)

(21) Appl. No.: 19/054,472

(22) Filed: Feb. 14, 2025

Related U.S. Application Data
(63) Continuation of application No. PCT/US2023/072329, filed on Aug. 16, 2023.
(60) Provisional application No. 63/371,698, filed on Aug. 17, 2022.

(51) Int. Cl. F24D 17/00

(52) U.S. Cl. CPC F24D 17/0005; F24D 2200/20

(57) ABSTRACT

Described herein are systems and methods for wastewater heat recovery, including a system for heat recovery, the system comprising: (i) a heat exchanger that is configured to heat water with thermal energy recovered from a wastewater stream, wherein the wastewater stream is treated by a wastewater treatment system that is in fluidic communication with the heat recovery system, and (ii) a device configured to control a flow rate of wastewater in the heat recovery system based at least in part on real-time sensor data.

### CROSS-REFERENCE

This application is a continuation of International Application No. PCT/US2023/072329 filed on Aug. 16, 2023, which claims priority to U.S. Provisional Application No. 63/371,698 filed on Aug. 17, 2022, the content of which is incorporated herein in its entirety.

### BACKGROUND

The use of hot water within a building, including hot water used in showers, lavatories, clothes washing, etc., increases the temperature of wastewater flows. This hot water is a valuable source of heat for other uses within the building. A heat recovery module converts the heat in wastewater into usable heat for applications such as pre-heating water for boilers or hot water tanks. Current heat recovery technology may employ use of heat pump(s). Heat pump technology uses electricity and the reverse refrigeration cycle to transfer heat from one place to another. However, heat pumps can be expensive, requiring high capital cost and complex set up. An alternative option is a heat exchanger, which is a passive technology that does not require any external energy source. Heat exchangers facilitate the transfer of internal thermal energy between two fluids without mixing of the two. A heat exchanger can be used to transfer thermal energy from a wastewater stream to another source, such as the building hot water supply. Heat exchangers require that the wastewater has a high enough temperature to heat the building water loop. However, current heat exchanger systems may have poor heat recovery performance when integrated with a wastewater treatment system. For instance, although raw wastewater has the highest amount of thermal energy prior to treatment, poor water quality and the presence of impurities may result in high operational cost. Treated water has higher quality, but thermal energy is lost during transportation through the wastewater treatment system, resulting in low heat recovery performance.

### SUMMARY

A need exists for a heat recovery system with reduced cost without significantly compromising the heat recovery performance. Also, a need exists for the heat recovery system that can be integrated with a new or existing wastewater treatment system in an easy and convenient manner. The present disclosure provides systems and methods for recovering the heat and energy present in wastewater. Wastewater, which may have an increased temperature due to hot water uses throughout a building, provides a valuable but underutilized source of thermal energy. The methods and systems described herein may convert the heat and energy present in wastewater into usable energy. In some cases, the recovered energy may be used for other uses within the building, including pre-heating water for boilers or hot water tanks.

Various advantages of the embodiments described herein are: they provide an efficient, cost-effective, on-site wastewater heat recovery for building(s) (e.g., commercial and residential buildings, food and industrial processing facilities) or other entities; they capture heat to be used in generating hot water for various domestic and industrial process use or for space heating; they generally conserve water and energy; and they are simple to integrate.

Described herein is an improved system for wastewater heat recovery. In an aspect, provided herein, is a system comprising: (i) a heat exchanger that is configured to heat water with thermal energy recovered from a wastewater stream, wherein the wastewater stream is treated by a wastewater treatment system that is in fluidic communication with the heat recovery system, and (ii) a device configured to control a flow rate of wastewater in the heat recovery system based at least in part on real-time sensor data.

In some embodiments, the wastewater is at least partially treated by the wastewater treatment system prior to entering the heat recovery system. In some embodiments, the heat exchanger comprises a plate and frame heat exchanger. In some embodiments, the wastewater is treated by the wastewater treatment system after exiting the heat recovery system. In some embodiments, the heat exchanger comprises a shell and tube heat exchanger. In some embodiments, the system further comprises a screening system. In some embodiments, the device is configured to control the flow rate of wastewater based at least in part on the temperature of the wastewater stream. In some embodiments, the device is configured to increase the flow rate of wastewater when the temperature of the wastewater stream is above a threshold value. In some embodiments, the device is configured to decrease the flow rate of wastewater when the temperature of the wastewater stream is below a threshold value. In some embodiments, the device is configured to control the flow rate of wastewater based at least in part on demand for heated water. In some cases, the device is configured to increase the flow rate of wastewater through the system when the demand for heated water is above a threshold value. In some cases, the is configured to increase the flow rate of wastewater through the system when the demand for heated water is above a threshold value.

In some embodiments, the system further comprises a wastewater holding tank. In some embodiments, the device is configured to control the flow rate of wastewater based at least in part on the amount of wastewater present in the wastewater holding tank. In some embodiments, the device is configured to shut off when the amount of wastewater present in the wastewater holding tank is below a threshold level. Alternatively, or additionally, the pump is configured to shut off when a temperature of the wastewater tank is below a predetermined threshold.

In some embodiments, the heat recovery system is contained within a complete skid mounted system. In some embodiments, the complete skid mounted system is configured to be added to an existing wastewater treatment system. In some embodiments, the system is located at a location that is within a wastewater source. In some embodiments, the wastewater source is a building, and the system is located in a basement of the building. Alternatively, the system can be located in any suitable places inside or outside of a building. In some embodiments, the system is fully automated. In some cases, at least a portion of the wastewater used by the heat recovery system is not fully treated by the wastewater treatment system. In some cases, the device is a pump. In some cases, the device is a valve. In some cases, the wastewater source is a building, and the system is located outside of the building. In some cases, the system is located off-site from the wastewater source.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 illustrates an integrated wastewater treatment and heat recovery process, in accordance with some embodiments;

FIG. 2 illustrates a process-flow diagram of an integrated wastewater treatment and heat recovery process, in accordance with some embodiments;

FIG. 3 illustrates a 30,000 gallon per day wastewater treatment system that incorporates wastewater heat recovery, in accordance with some embodiments;

FIG. 4 illustrates a 37,000 gallon per day wastewater treatment system that incorporates wastewater heat recovery, in accordance with some embodiments;

FIG. 5 illustrates a 50,000 gallon per day wastewater treatment system that incorporates wastewater heat recovery, in accordance with some embodiments;

FIG. 6A illustrates a Shell & Tube heat exchanger, in accordance with some embodiments;

FIG. 6B illustrates a cutaway view of a Shell & Tube heat exchanger, in accordance with some embodiments;

FIG. 7 illustrates a Plate & Frame heat exchanger, in accordance with some embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The present disclosure provides systems and methods for recovering the heat and energy present in wastewater. Wastewater may come from a source, such as a building or any other type of structure. In some embodiments, a wastewater source may be the municipal sewer. A building may be a residential building, commercial building, industrial building or any other type of building. A source of the water may be a high density building or other structure. A high density source may have a large number of water consumption sources. A high density source may have at least 5, 10, 15, 20, 30, 40, 50, 70, 100 or more water consumption sources within a structure. Examples of wastewater sources may comprise, but are not limited to, apartment buildings, townhouses, single family homes, office buildings, educational facilities, manufacturing facilities, medical facilities, government buildings, stores, or any other type of structure. A wastewater source may be a group of buildings. In some cases, a wastewater source is a campus, a district, or a municipality. In some embodiments, a wastewater source may comprise a multi-family housing unit such as an apartment building. In some embodiments, an apartment building may comprise any number of apartment units. For example, an apartment building may comprise 10 units, 20 units, 50 units, 100 units, 250 units, 500 units, 750 units, 1000 units, 5000 units or any other number of units. Examples of water consumption sources may include toilets, sinks, showers, laundry machines, dishwashers, cooling towers, and irrigation systems, among other examples. Wastewater from one or more water consumption sources or one or more wastewater sources may be collected on-site or near the wastewater source.

In some embodiments, the heat recovery system may employ use of a heat exchanger integrated with an improved control mechanism that may optimize portions of the process and therefore reduce operating cost. Wastewater may often be elevated in temperature as a result of the application for which it was used. For example, hot water used in showers, cooking, cleaning, washing clothes, etc. may elevate the temperature of a wastewater stream. As heated wastewater travels through a building and undergoes treatment or goes to the sewer, the temperature of the stream may decrease until the temperature reaches ambient temperature. The thermal energy in the wastewater stream is therefore lost and cannot be recovered. Systems and methods herein recover the heat energy stored in wastewater streams and convert it into a usable heat source for various applications with improved performance.

In some embodiments, the heat recovery system herein may be applied at the wastewater treatment system level. The heat recovery system may be coupled to a wastewater treatment system and may dynamically adapt to the wastewater treatment process, recovering heat from treated wastewater, untreated wastewater or partially treated wastewater within the wastewater treatment system. The overall efficiency of the heat recovery and wastewater treatment may be improved by avoiding unnecessary treatment of the unusable wastewater while collecting the energy of such water for heat recovery. In some embodiments, the integrated heat recovery and wastewater treatment system may comprise an automated control system configured to perform wastewater diversion timing and recovery extraction thereby maximizing the system uptime and heat recovery capability. Details about the automatic control are described later herein.

A wastewater treatment and heat recovery system as provided herein may be located substantially on-site. This beneficially reduces the heat loss due to transportation. In some instances, portions of the wastewater treatment and heat recovery system may be located on-site while portions may be located at a remote central processing facility. Optionally, separation of wastewater into waste solid components and separated water components may occur on-site at or near the wastewater source (e.g., building). The separation may occur as a decentralized system. A solid waste product may be treated on-site or near the wastewater source, and/or may be treated at a remote processing facility. The separated water components may undergo treatment on-site or near the wastewater source. Heat recovery may occur substantially on-site. The recovered heat may be used for on-site uses.

On-site activities may occur at a location that is within a wastewater source (e.g., building). The location may be partially within a wastewater source. The location may also be physically outside of a wastewater source but operably connected to the wastewater source so that the location is within, or connected to, the site of the wastewater source. For instance, the on-site activity may be on the same property of the wastewater source. The on-site activity may occur under the wastewater source. The on-site activity may occur underground. In some examples, activities may occur near a site. For example, activities (e.g., wastewater heat recovery) may occur within three blocks, within two blocks, within one block, within a hundred feet, within fifty feet, within forty feet, within thirty feet, within twenty feet, or within ten feet of the wastewater source (e.g., building) or a property on which the wastewater source resides. For example, activities (e.g., wastewater heat recovery) may occur more than a mile from a wastewater source (e.g., building) or a property on which the wastewater source resides.

In some embodiments, the amount of wastewater that flows through the wastewater heat recovery system is about 5,000 gallons/day to about 1,000,000 gallons/day, and any amount below 5,000 gallons/day or above 1,000,000 gallons/day. In some embodiments, the amount of water that flows through the wastewater heat recovery system is about 5,000 gallons/day to about 1,000,000 gallons/day. In some embodiments, the amount of water that flows through the wastewater heat recovery system is about 5,000 gallons/day to about 20,000 gallons/day, about 5,000 gallons/day to about 60,000 gallons/day, about 5,000 gallons/day to about 100,000 gallons/day, about 5,000 gallons/day to about 500,000 gallons/day, about 5,000 gallons/day to about 1,000,000 gallons/day, about 20,000 gallons/day to about 60,000 gallons/day, about 20,000 gallons/day to about 100,000 gallons/day, about 20,000 gallons/day to about 500,000gallons/day, about 20,000 gallons/day to about 1,000,000 gallons/day, about 60,000 gallons/day to about 100,000 gallons/day, about 60,000 gallons/day to about 500,000 gallons/day, about 60,000 gallons/day to about 1,000,000 gallons/day, about 100,000 gallons/day to about 500,000 gallons/day, about 100,000 gallons/day to about 1,000,000 gallons/day, or about 500,000 gallons/day to about 1,000,000 gallons/day. In some embodiments, the amount of water that flows through the wastewater heat recovery system is about 5,000 gallons/day, about 20,000 gallons/day, about 60,000 gallons/day, about 100,000 gallons/day, about 500,000 gallons/day, or about 1,000,000 gallons/day. In some embodiments, the amount of water that flows through the wastewater heat recovery system is at least about 5,000 gallons/day, about 20,000 gallons/day, about 60,000 gallons/day, about 100,000 gallons/day, or about 500,000 gallons/day. In some embodiments, the amount of water that flows through the wastewater heat recovery system is at most about 20,000 gallons/day, about 60,000 gallons/day, about 100,000 gallons/day, about 500,000 gallons/day, or about 1,000,000 gallons/day.

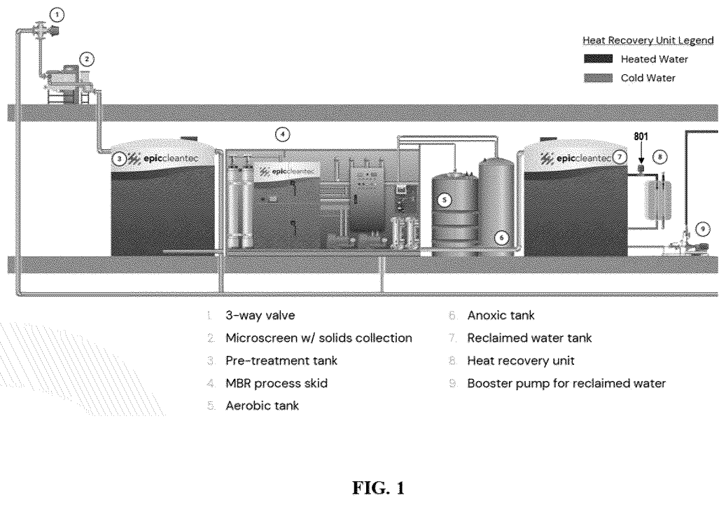

FIG. 1 illustrates an example of an integrated wastewater heat recovery and wastewater treatment system. Wastewater may enter through a valve 1. In some cases, this valve is a 3-way valve. In one direction, wastewater may be directed through the integrated heat recovery and wastewater treatment system. In the other direction, wastewater may be directed to the sewer and bypass the wastewater treatment and heat recovery system. This valve can be manually or automatically adjusted. The 3-way valve can be used to divert wastewater to the sewer if the wastewater treatment system is undergoing maintenance or an error occurs within the system. Once wastewater enters the treatment system, it may flow through a screening unit such as a microscreen 2. This screening unit (e.g., microscreen 2) can be used to filter and collect solids present in the wastewater.

Next, the wastewater may enter a pre-treatment tank 3. In some cases, the pre-treatment tank 3 may be equipped with sensors. In some instances, the sensors may include a temperature sensor measuring the temperature of the water in the pre-treatment tank. The temperature sensor may be located at any location of the tank, the inlet/outlet of the tank and the like. In some instances, the sensors may comprise a sensor for measuring a level of the water in the pre-treatment tank. In some cases, at least a portion of the water in the pre-treatment tank may be used in the heat recovery system to conduct heat exchanging with building water that is to be heated. In some cases, at least a portion of the water in the pre-treatment tank may be pumped to the heat recovery system. The sensor for measuring the level of water may beneficially protect the pump. Any suitable sensor can be utilized for sensing the water level. For example, the sensor may be contact or non-contact devices. The non-contact sensor may be ultrasonic or hydrostatic sensor. The sensor data about the temperature and/or level in the tank may be processed by a controller of the heat recovery system to control the pump in the heat recovery system, trigger alarms and/or other actions of the heat recovery system and/or the wastewater treatment system.

The wastewater, which has been filtered of solids, may then flow through a series of treatment and disinfection processes. Wastewater may enter a membrane bioreactor (“MBR”) process skid 4. The MBR process may include membrane process such as microfiltration or ultrafiltration combined with a biological wastewater treatment process, the activated sludge process.

Additionally, the wastewater may flow through an aerobic tank 5 and/or an anoxic tank 6 for further treatment. For example, nitrogen and phosphorus removal may be performed by microbial decomposition in the tank. Treated wastewater can then flow to UV and/or chlorine dosing for disinfection, and then into a reclaimed water tank 7. In some embodiments, the heat recovery system may be located near the reclaimed water tank. The reclaimed water tank may also be referred to as treated water storage tank or holding tank which are exchangeable throughout the specification.

The heat recovery system may be in fluid communication with the reclaimed water tank 7. In some embodiments, the reclaimed water tank 7 may be equipped with sensors that measure the temperature or level or other conditions of the treated wastewater. The temperature sensor and/or the water level sensor can be the same as those described above.

The wastewater may enter the heat recovery portion of the process through a heat recovery unit (system) 8. The heat recovery unit 8 may comprise a heat exchanger or a series of heat exchangers. The thermal energy present in the treated wastewater may be transferred to another fluid using the heat recovery unit 8. In some embodiments, the heat recovery unit 8 may comprise a pump or valve 9 to control the flow in the heat recovery system. In some cases, the pump or valve may be used to control the treated wastewater flowing into the heat exchanger. In some cases, a pump or control valve may be used to control flow of the building water to be heated in the heat exchanger. After the wastewater has passed through the heat recovery unit 8, it can be routed back into the reclaimed water tank 7 via a pipe. In some cases, a control valve 801 may be integrated into the pipe. The control valve 801 may be used to control the flow of wastewater in the heat recovery system.

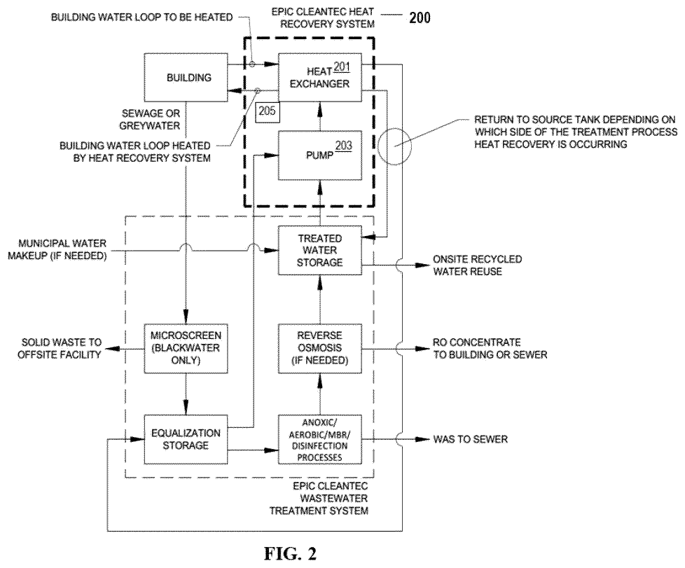

FIG. 2 schematically shows an example of an integrated wastewater heat recovery and wastewater treatment system. The system may be located onsite of a structure (e.g., within a building) or exterior to a structure. In some embodiments, the integrated heat recovery and wastewater treatment system is located in the basement of a building. Wastewater, including sewage (blackwater), greywater, or process wastewater may flow from the building into the integrated wastewater heat recovery and wastewater treatment system. Wastewater may flow into the integrated wastewater heat recovery and wastewater treatment system through the building's collection pipes. Wastewater from the building may come from sources such as industrial processes, water closets (WC, or “toilets”), urinals, bathtubs, showers, or sinks. Other sources may include dishwashers and washing machines, for example. The wastewater may be elevated in temperature due to its use within the building. For example, wastewater may be heated for showering, laundry, or washing dishes. Wastewater that contains sewage (blackwater) may flow from a building via one or more pipes through a microscreen or other screening process. The microscreen may separate solid waste from blackwater. The solid waste may be sent to an offsite facility. The remaining wastewater, now without solid waste, may then flow to an equalization storage tank. Greywater (wastewater that does not contain human waste) may flow from a building via one or more pipes and flow directly to an equalization storage tank, bypassing screening. In some cases, multiple equalization storage tanks (also called holding tanks) are used. The equalization or holding tank (or tanks) will typically be designed to manage peak flows of the system to which it is attached. From the equalization storage or holding tank, a wastewater stream may flow to the heat recovery system. The heat recovery system may comprise one or more pumps and a heat exchanger. The heat exchanger may be used to facilitate heat transfer from the warm wastewater to another water stream. The other water stream may be domestic water. The heated domestic water may exit the heat exchanger and flow to a domestic hot water storage tank or flow directly for use in the building. In some embodiments, the wastewater stream exits the equalization storage tank and enters a treatment and disinfection process. A treatment and disinfection process may comprise an anoxic process, aerobic process, MBR process, UV disinfection, ozone contact, activated carbon, chlorine disinfection, or a combination thereof. The treatment and disinfection process may produce waste activated sludge (WAS). The waste activated sludge may exit the wastewater treatment process and enter the sewer. The treated wastewater may exit the treatment processes and undergo reverse osmosis if needed. The reverse osmosis process may produce a reverse osmosis concentrate. The reverse osmosis concentrate stream may flow back to the building or flow into the sewer. The treated wastewater may leave the reverse osmosis process and enter a treated water storage tank. If reverse osmosis is not needed, the treated wastewater may flow directly from the treatment and disinfection processes to a treated water storage tank. The treated water storage tank may also be filled by municipal water, if needed. The treated wastewater may be reused onsite or off-site. In some cases, a treated wastewater stream may flow to the heat recovery system. The heat recovery system may comprise one or more pumps and a heat exchanger. The heat exchanger may be used to facilitate heat transfer from the treated wastewater to another water stream. The other water stream may be domestic water. The heated domestic water may exit the heat exchanger and flow to a domestic hot water storage tank or flow directly for use in the building.

According to various embodiments, multiples of any of the components of the integrated heat recovery and wastewater treatment system may be provided. In various alternative embodiments, wastewater treatment and heat recovery system may include fewer or larger numbers of components than described above. For example, any one of the components described above, or any combination of components, may be provided in multiples (e.g., multiple equalization storage tanks, multiple heat exchangers, multiple pumps, etc.). In some embodiments, one or more components may be removed from system. For example, in one embodiment, the equalization storage tank(s) may be eliminated. In alternative embodiments, the wastewater treatment and heat recovery system may include any of a number of other configurations, combinations of components, sizes, shapes and the like, such as but not limited to one or more of the components or aspects described above in relation to FIG. 2.

Before the wastewater enters a treatment process, the wastewater may initially pass through a screening process. In some embodiments, the wastewater may pass through a screening process prior to heat recovery. In some embodiments, the wastewater may pass through a screening process after heat recovery. The screening process may be used to remove solid materials that are above a size threshold. For example, a screening process may remove material that is more than the size of a grain of sand or golf ball. In some embodiments, the screening process may remove materials that have a maximum dimension (e.g., length, width, height, diagonal, diameter) of greater than or equal to about 0.1 mm, 0.5 mm, 1 mm, 1.5 mm, 2 mm, 2.5 mm, 3 mm, 3.5 mm, 4 mm, 5 mm, 7 mm, or 10 mm. The materials may comprise inorganic or organic solid materials. The screening process may remove inorganic objects that are improperly flushed down a toilet. For example, the screening process may be used to remove inorganic objects such as children's toys, wrappers, or other materials improperly flushed down a toilet. In some cases, a screening process may utilize one or more screens. The screens may be selected from the group consisting of a coarse screen, a fine screen, and a microscreen. In some instances, a single screen may be used to capture the larger solid materials. Alternatively, a plurality of screens may be provided in series or in parallel. Once the larger solid materials are removed from the wastewater, they may be discharged to the sewer or collected periodically. In another example, once the larger solid materials are removed from the wastewater, they may be disposed of periodically or processed offsite for reuse as a soil amendment. Once the larger solid materials have been screened from the wastewater, a valve may be used to divert the wastewater flow into a heat exchanger. In some cases, at least a portion of the wastewater may not pass through a screening process prior to entering the wastewater treatment and heat recovery process described herein.

One or more pumps may be used to move the warm wastewater through a heat exchanger. The heat exchanger may be located in close proximity to a wastewater treatment system. Alternatively, the heat exchanger may be located at any distance from the wastewater treatment system. In some embodiments, heat recovery may occur prior to wastewater treatment. In some embodiments, the temperature of the warm wastewater stream prior to entering a wastewater treatment system is about 65° F. to about 90° F. In some embodiments, the temperature of the wastewater stream prior to entering a wastewater treatment system is about 65OF to about 70° F., about 65° F. to about 72° F., about 65° F. to about 75° F., about 65° F. to about 78° F., about 65° F. to about 80° F., about 65° F. to about 85° F., about 65° F. to about 90° F., about 70° F. to about 72° F., about 70° F. to about 75° F., about 70° F. to about 78° F., about 70° F. to about 80° F., about 70° F. to about 85° F., about 70° F. to about 90° F., about 72° F. to about 75° F., about 72° F. to about 78° F., about 72° F. to about 80° F., about 72° F. to about 85° F., about 72° F. to about 90° F., about 75° F. to about 78° F., about 75° F. to about 80° F., about 75° F. to about 85° F., about 75° F. to about 90° F., about 78° F. to about 80° F., about 78° F. to about 85° F., about 78° F. to about 90° F., about 80° F. to about 85° F., about 80° F. to about 90° F., or about 85° F. to about 90° F. In some embodiments, the temperature of the wastewater stream prior to entering a wastewater treatment system is about 65° F., about 70° F., about 72° F., about 75° F., about 78° F., about 80° F., about 85° F., or about 90° F. In some embodiments, the temperature of the wastewater stream prior to entering a wastewater treatment system is at least about 65° F., about 70° F., about 72° F., about 75° F., about 78° F., about 80° F., or about 85° F. In some embodiments, the temperature of the wastewater stream prior to entering a wastewater treatment system is at most about 70° F., about 72° F., about 75° F., about 78° F., about 80° F., about 85° F., or about 90° F.

Once the wastewater stream exits the wastewater treatment and heat exchanger, one or more pumps may move the wastewater through a wastewater treatment system. In some embodiments, a valve or pump is used to route the wastewater into a wastewater treatment system.

The heat recovered from the wastewater may be transferred to on-site or nearby heating demands. The recovered heat may facilitate on-site space and/or water heating. In some embodiments, the recovered thermal energy may be converted into another form of energy. For example, recovered thermal energy may be converted into mechanical energy, electrical energy, or a combination thereof. In some embodiments, thermal energy recovered from the wastewater may be used in the on-site wastewater treatment process. In some cases, the thermal energy recovered from the wastewater may decrease the energy input required for the wastewater treatment process.

In some embodiments, the heat recovered from the wastewater may be used for on-site heating of domestic water. In other embodiments, the heat recovered from the wastewater may be used for on-site heating of treated wastewater (reclaimed or recycled water). The temperature of the cold domestic water, prior to introduction of the recovered heat, may be about 40° F., 45° F., 50° F., 55° F., 60° F., 65° F., 70° F., or 75° F. The heat recovered from the wastewater may be transferred to heat domestic water to a temperature of about 60° F., 70° F., 80° F., 90° F., 100° F., 110° F. or 120° F. Domestic water may flow through a heat exchanger configured for heat transfer between two fluids. In some embodiments, cold domestic water enters a heat exchanger at a first input site and warm wastewater enters a heat exchanger at a second input site. The heat exchanger may facilitate heat transfer between two fluids. In some embodiments, thermal energy present in the warm wastewater is transferred to the cold domestic water, resulting in domestic water of an increased temperature. In some embodiments, this heated domestic water is used on-site for domestic use. For example, this heated domestic water can be used for laundry, taking showers, washing clothes, and the like.

In some embodiments, the heat recovery system 200 may comprise a heat exchanger 201, a pump 203 and a controller 205. In some cases, the pump 203 may be a variable frequency drive (VFD) pump or single speed pump. The pump may comprise a motor controller that drives an electric motor by varying the frequency and voltage supplied to the electric motor such that the pump can operate at variable speeds (e.g., range of flow rates) without the use of additional gear box or switching to a different electric motor. The VFD pump is capable of adjusting the operation of the pump on the fly to adapt to the uneven density of wastewater. This beneficially reduces the pump's power consumption, reducing the cost, and increasing the energy efficiency. A flow control valve may be used to modulate pump discharge flowrate instead of changing the pump motor speed.

The controller 205 may perform flow control in the heat recovery system 200. In some embodiments, the controller 205 may be operably coupled to the motor controller of the pump 203 and automatically adjust the speed or other operations of the pump (e.g., switch on/off). In some embodiments, the controller 205 may control the flow based on sensor data. For example, the sensor data may include temperature of the wastewater (e.g., treated or partially treated) and the controller may execute a proprietary or non-proprietary control algorithm to adjust the speed and activation timing of the pump. The control algorithm may maximize the heat recovery while reducing the cost of the system.

In some embodiments, the controller and/or the control algorithm may be part of a process control system that is integrated into the wastewater treatment and heat recovery system to optimize heat recovery or control wastewater diversion timing, or a combination thereof. The sensors located at the tanks, inlet/outlet of the heat exchanger 201 may also be part of the process control system. Data captured by the sensors may be transmitted to the controller or process control system via cables or wirelessly.

In some cases, the control algorithm may control the flow or operations of the heat recovery system based at least part on the status of the wastewater treatment process and/or demand of the building water. In some cases, the control algorithm may be executed by the process control system to control both the wastewater treatment process and heat recovery in a coordinated manner to improve the overall performance of the integrated wastewater treatment and heat recovery. Wastewater collection and flow through a building network may depend on the demand and use of water at a given time. There may be certain periods of the day where more hot water flows into a wastewater collection system. For example, an increased amount of hot wastewater may flow into a wastewater treatment system in the morning because residents of a building take hot showers before they begin their day. Similarly, increased hot water flow can be the result of increased laundry and dishwasher use. In some cases, a building's demand for non-potable water is less than the amount of wastewater being supplied to an integrated heat recovery and wastewater treatment system, so a portion of the building wastewater flows may be diverted to the sewer. The process control system may execute a control algorithm to prioritize and automatically determine when diversion of wastewater to the sewer is necessary to maximize heat recovery while balancing non-potable supply needs for the building. For example, when the non-potable supply needs for the building are below a threshold, the building wastewater flows may be diverted to the sewer without unnecessary treatment. In some cases, the control algorithm may be capable of predicting and/or forecasting a demand for hot building water and may dynamically adjust the diversion of wastewater (e.g., time window, amount, etc.) based on the predicted demand. The overall efficiency of the heat recovery and wastewater treatment may be improved by avoiding unnecessary treatment of the unusable wastewater while collecting the energy of such water for heat recovery.

In some cases, the process control system can control heat recovery to maximize heat recovery capability and maximize uptime. During times in which there is limited or no heat recovery capacity, the system may automatically adjust flow rate in the heat recovery system 200 such as by controlling the pump 203 speed or shutting down pumps to save energy and limit wear on components. In some cases, based on the real-time sensed temperature or level of water in the tank, the system may determine a heat recovery capacity and may adjust the pump (e.g., ramp down or shut down) based on the heat recovery capacity. For example, when the heat recovery capacity is below a threshold, the pump may be shut down.

A process control system may comprise sensors for measuring temperature, pressure, flow rates, or additional process/operational parameters. Temperature sensing may occur at a wastewater holding tank, at the water source that is to be preheated, at the inlet and/or outlet of a heat exchanger, or at any other point in the wastewater treatment and heat recovery process. Temperature sensing may be used to track the system efficiency. Temperature sensing may also be used to allow for control of a pump speed and thereby heat extraction. As described above, the heat recovery operation may be controlled based on the real-time temperature and/or the hot water demand. For example, during periods where the building needs more hot water, a pump speed may increase to meet the increased heat recovery demand and slow down when the building needs decrease.

In some cases, when the temperature of the wastewater in a holding tank is above a pre-determined threshold, the controller 205 may issue command to the pump increasing the speed of the pump until the temperature drops back to a pre-determined range. In some cases, when the temperature of the wastewater in a holding tank is below a pre-determined threshold indicating insufficient heat recovery capacity, controller 205 may issue a command to the pump to slow down the speed or shut it off, thereby reducing operating cost and minimizing wear and tear on components when heat recovery potential is low.

In some cases, a process control system may measure a site's demand for hot domestic water. In some cases, these measurements can take place in real time. The demand for water within a building or site can be measured using an inline flowmeter for continuous real time data collection. In some cases, the temperature setpoint of domestic hot water can be determined automatically through an inline thermocouple. In some cases, the temperature setpoint of domestic hot water is set by an operator. The temperature setpoint of domestic hot water needs may vary based on building hot water needs, time of day, and time of year, among various other factors. An operator may set a temperature setpoint. This temperature setpoint can be adjusted to accommodate changing hot water demands, climate conditions, and seasonality, among other factors. In some cases, the process control system may control the wastewater treatment process and/or heat recovery operation based on predicted demand for hot domestic water. The prediction may be made based on historical data and/or real-time sensor data. The demand for hot domestic water may be predicted for an upcoming forecast horizon such as in a future period of 10 minutes, 20 minutes, 30 minutes, 1 hour, 2 hours, 3 hours, and the like.

A process control system may be capable of performing automated operation. In some embodiments, a process control system may protect pumps from operating in low water level conditions based at least in part on level sensor data. This can maximize system operating time or uptime and reduce operational cost burdens. The level of a tank can be measured using an inline device placed within the tank. In some cases, the inline device contacts the wastewater within the tank. In some cases, the inline device does not contact the wastewater within the tank. In some cases, the level within a tank can be measured using a hydrostatic device. A hydrostatic device may comprise a displacer, a bubbler, or a differential pressure transmitter, or a combination thereof. In some cases, the level within a tank is measured using an ultrasonic device. In some cases, the level within a tank is measured using laser or radar level transmitters. By continuously measuring the level in the tank, the number of level points for alarms and actions can be unlimited via programming in the control system. When a low-level condition is detected, an automatic control system can reduce the speed of the pump or shut it off completely. In some cases, the height of a pump suction can determine the low-low level cutoff as this is the physical point at which the pump is sucking in air instead of pumping water. In an example, the low-level cutoff point may be around 10″ from the bottom of a tank. The low-level cutoff may be customizable and adjusted for a specific application or the physical dimension of the components.

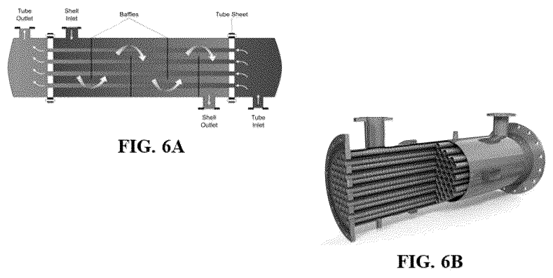

The heat recovery system may comprise of one or more pumps 203 to move the warm wastewater stream to one or more heat exchangers 201. The warm wastewater stream may enter one or more heat exchangers prior to wastewater treatment. In some embodiments, the heat exchanger 201 may be a shell and tube heat exchanger. FIGS. 6A and 6B illustrate a shell and tube heat exchanger. A shell and tube heat exchanger allows two fluids to come into thermal contact to exchange heat. In some embodiments, the first fluid is warm wastewater. In some embodiments, the second fluid is cold domestic water. In some embodiments, the second fluid is a circulating fluid such as ammonia, water, a water-glycol mix, or a refrigerant. The heat captured in the circulating fluid may be utilized for various on-site uses. In some embodiments, the two fluids comprise warm wastewater and a circulating fluid from the building that is to be heated. One fluid flows over the outside of the tubes while the second fluid flows through the tubes. The fluids can be in gas phase, liquid phase, or a combination thereof. The fluids can be single or two phases. The shell and tube heat exchanger may operate in a parallel, cross, or counter flow arrangement. A parallel flow arrangement is when the shell and tube fluids enter the heat exchanger on the same side and flow, in parallel, to the opposite end. A counter flow heat exchanger is when the shell and tube fluids enter the heat exchanger on opposite ends. The fluids flow in opposite directions and discharge at opposite ends of the heat exchanger. In a cross flow shell and tube heat exchanger, the fluids flow perpendicular to each other at about a 90° angle. FIG. 6A shows a shell and tube heat exchanger with two inlets and two outlets, where each fluid starts at their respective inlet and exits the device at their outlets. The tube-side flow passes through the tubes (secured by metal plates known as tubesheets) and exits the tube outlet. Similarly, the shell-side flow starts at the shell inlet, passes over the tubes, and exits at the shell outlet. Baffles maximize the amount of thermal mixing that occurs between the shell-side fluid and the fluid in the tubes. A shell and tube heat exchanger may be a U-tube heat exchanger, a fixed tube sheet exchanger, or a floating head heat exchanger.

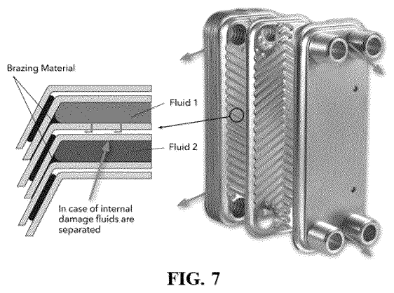

In some embodiments, the one or more heat exchangers may be a plate and frame heat exchanger. FIG. 7 illustrates an example of a plate and frame heat exchanger. A plate and frame heat exchanger may comprise two end members that hold together a number of heat transfer plates. A plate and frame heat exchanger allows for heat transfer between two fluids using multiple heat transfer plates. In some embodiments, the first fluid is warm wastewater. In some embodiments, the second fluid is cold domestic water. In some embodiments, the second fluid is a circulating fluid such as ammonia, water, a water-glycol mix, or a refrigerant. The heat captured in the circulating fluid may be utilized for various on-site uses. In some embodiments, one or more pumps moves the second fluid through the heat exchanger. Two fluids may flow through alternate channels in a counter-current fashion. The fluids can be in gas phase, liquid phase, or a combination thereof. The fluids can be single or two phase. Plates may be corrugated to create turbulence in the fluids as they flow through the heat exchangers. This turbulence may increase the amount of heat transferred between the two fluids. Plates may be constructed of stainless steel, titanium, aluminum, copper, Hastelloy, Avesta 254 SMO, Avesta 254 SLX, or any material ductile enough to be formed into a pressed plate. Plates may be between 0.5 and 2.5 mm thick, or can have a thickness below 0.5 mm or greater than 2.5 mm. The heat transfer plates may be separated by a gasket which seals the plates and arranges the flow of fluids between the plates. A gasket may prevent mixing of the two fluids in case of internal damage to the heat exchanger. The heat transfer plates may be brazed together using a brazing material. The brazing material may comprise copper, nickel, silver, aluminum, or gold, or a combination thereof.

After leaving the heat exchanger and prior to entering wastewater treatment, the wastewater stream may have a temperature of about 60° F. to about 75° F. After leaving the heat exchanger and prior to entering wastewater treatment, the wastewater stream may have a temperature of about 60° F. to about 62° F., about 60° F. to about 64° F., about 60° F. to about 65° F., about 60° F. to about 66° F., about 60° F. to about 68° F., about 60° F. to about 70° F., about 60° F. to about 72° F., about 60° F. to about 74° F., about 60° F. to about 75° F., about 62° F. to about 64° F., about 62° F. to about 65° F., about 62° F. to about 66° F., about 62° F. to about 68° F., about 62° F. to about 70° F., about 62° F. to about 72° F., about 62° F. to about 74° F., about 62° F. to about 75° F., about 64° F. to about 65° F., about 64° F. to about 66° F., about 64° F. to about 68° F., about 64° F. to about 70° F., about 64° F. to about 72° F., about 64° F. to about 74° F., about 64° F. to about 75° F., about 65° F. to about 66° F., about 65° F. to about 68° F., about 65° F. to about 70° F., about 65° F. to about 72° F., about 65° F. to about 74° F., about 65° F. to about 75° F., about 66° F. to about 68° F., about 66° F. to about 70° F., about 66° F. to about 72° F., about 66° F. to about 74° F., about 66° F. to about 75° F., about 68° F. to about 70° F., about 68° F. to about 72° F., about 68° F. to about 74° F., about 68° F. to about 75° F., about 70° F. to about 72° F., about 70° F. to about 74° F., about 70° F. to about 75° F., about 72° F. to about 74° F., about 72° F. to about 75° F., or about 74° F. to about 75° F. After leaving the heat exchanger and prior to entering wastewater treatment, the wastewater stream may have a temperature of about 60° F., about 62° F., about 64° F., about 65° F., about 66° F., about 68° F., about 70° F., about 72° F., about 74° F., or about 75° F.

In some embodiments, the amount of energy extracted from the warm wastewater is about 500,000 BTU/day to about 100,000,000 BTU/day, or any amount below 500,000 BTU/day or above 100,000,000 BTU/day. In some embodiments, the amount of energy extracted from the warm wastewater is about 500,000 BTU/day to about 100,000,000 BTU/day. In some embodiments, the amount of energy extracted from the warm wastewater is about 500,000 BTU/day to about 1,000,000 BTU/day, about 500,000 BTU/day to about 5,000,000 BTU/day, about 500,000 BTU/day to about 20,000,000 BTU/day, about 500,000 BTU/day to about 50,000,000 BTU/day, about 500,000 BTU/day to about 100,000,000 BTU/day, about 1,000,000 BTU/day to about 5,000,000 BTU/day, about 1,000,000 BTU/day to about 20,000,000 BTU/day, about 1,000,000 BTU/day to about 50,000,000 BTU/day, about 1,000,000 BTU/day to about 100,000,000 BTU/day, about 5,000,000 BTU/day to about 20,000,000 BTU/day, about 5,000,000 BTU/day to about 50,000,000 BTU/day, about 5,000,000 BTU/day to about 100,000,000 BTU/day, about 20,000,000 BTU/day to about 50,000,000 BTU/day, about 20,000,000 BTU/day to about 100,000,000 BTU/day, or about 50,000,000 BTU/day to about 100,000,000 BTU/day. In some embodiments, the amount of energy extracted from the warm wastewater is about 500,000 BTU/day, about 1,000,000 BTU/day, about 5,000,000 BTU/day, about 20,000,000 BTU/day, about 50,000,000 BTU/day, or about 100,000,000 BTU/day. In some embodiments, the amount of energy extracted from the warm wastewater is at least about 500,000 BTU/day, about 1,000,000 BTU/day, about 5,000,000 BTU/day, about 20,000,000 BTU/day, or about 50,000,000 BTU/day. In some embodiments, the amount of energy extracted from the warm wastewater is at most about 1,000,000 BTU/day, about 5,000,000 BTU/day, about 20,000,000 BTU/day, about 50,000,000 BTU/day, or about 100,000,000 BTU/day. Once the wastewater stream exits a heat exchanger, one or more pumps may move the wastewater through a wastewater treatment system. In some embodiments, a valve is used to divert the wastewater into a wastewater treatment system.

Upon entry into a wastewater treatment system, wastewater may be held in a holding tank. In some examples, a holding tank may be used to keep excess wastewater at bay if the treatment process is at its capacity. In some examples, a three-way valve may be used as an emergency bypass to the sewer. In examples, if a treatment process is at its capacity, and a holding tank is full, excess wastewater from a building may be released to the sewer using the emergency bypass.

The various embodiments of a wastewater treatment system and method described herein provide for wastewater treatment with improved efficiency and use of water and energy. In some embodiments, the treated solid waste may be used as fertilizer or soil amendment. Wastewater that is separated from the solid waste during the treatment process may be treated and disinfected for use in toilets, cooling towers, washing clothes, irrigating landscaping or other environmentally safe uses. The various embodiments may be used in any of a large number of settings and locations to provide efficient and effective wastewater treatment.

The terms “waste,” “wastewater” and “sewage” are sometimes used interchangeably in this application. Unless these terms are specifically described as having a particular meaning, they should be interpreted as being interchangeable.

In some embodiments, heat recovery may occur subsequent to wastewater treatment. Once the wastewater exits the wastewater treatment system, a valve may be used to divert the wastewater flow into one or more heat exchangers. One or more pumps may be used to move the warm wastewater through one or more heat exchangers. A heat exchanger may be located in close proximity or some distance to the outlet of a wastewater treatment system. In some embodiments, heat recovery may occur prior to wastewater treatment and subsequent to wastewater treatment. In some embodiments, the temperature of the warm wastewater stream after exiting a wastewater treatment system is about 65° F. to about 90° F. In some embodiments, the temperature of the wastewater stream after exiting a wastewater treatment system is about 65OF to about 70° F., about 65° F. to about 72° F., about 65° F. to about 75° F., about 65° F. to about 78° F., about 65° F. to about 80° F., about 65° F. to about 85° F., about 65° F. to about 90° F., about 70° F. to about 72° F., about 70° F. to about 75° F., about 70° F. to about 78° F., about 70° F. to about 80° F., about 70° F. to about 85° F., about 70° F. to about 90° F., about 72° F. to about 75° F., about 72° F. to about 78° F., about 72° F. to about 80° F., about 72° F. to about 85° F., about 72° F. to about 90° F., about 75° F. to about 78° F., about 75° F. to about 80° F., about 75° F. to about 85° F., about 75° F. to about 90° F., about 78° F. to about 80° F., about 78° F. to about 85° F., about 78° F. to about 90° F., about 80° F. to about 85° F., about 80° F. to about 90° F., or about 85° F. to about 90° F. In some embodiments, the temperature of the wastewater stream after exiting a wastewater treatment system is about 65° F., about 70° F., about 72° F., about 75° F., about 78° F., about 80° F., about 85° F., or about 90° F. In some embodiments, the temperature of the wastewater stream after exiting a wastewater treatment system is at least about 65° F., about 70° F., about 72° F., about 75° F., about 78° F., about 80° F., or about 85° F. In some embodiments, the temperature of the wastewater stream after exiting a wastewater treatment system is at most about 70° F., about 72° F., about 75° F., about 78° F., about 80° F., about 85° F., or about 90° F.

In some embodiments, the heat recovery system herein may be provided as a package that can be integrated into an existing wastewater treatment system in a convenient manner. In some cases, the heat recovery system may have a small footprint such as a complete skid mounted system. This complete skid mounted system can be integrated into an existing wastewater treatment process where heat recovery is desired. In some embodiments, the heat recovery system may comprise the pump, heat exchanger, sensors, and the controller as described above and may be coupled to the wastewater treatment system in a plug-and-play fashion without requiring change of the wastewater treatment system. This may facilitate ease of integration of the system into a building. In some cases, the integrated wastewater treatment and heat recovery system is installed in the basement of a building. Alternatively, reconfiguration of one or more components of an existing wastewater treatment system may be required to be coupled to the heat recovery system. For example, a skid mounted heat recovery system may include all the required sensors and instrumentation. The sensors and instrumentation can be tested prior to installation and shipment to the installation site. In some cases, temperature sensor (or other sensors) of the existing wastewater treatment system may be utilized by the heat recovery system. For instance, the controller of the heat recovery system may be in communication with the control system of the wastewater treatment system to retrieve the sensor data or other wastewater treatment status data to control the pump or operation of the heat recovery system.

In some cases, the heat recovery system herein may provide flexibility to be custom engineered to accommodate a pre-existing wastewater treatment site. For instance, the heat recovery system may be configured to be scaled up or down with respect to the flow capacity of an existing wastewater treatment system. For example, the heat recovery system may be scaled up by increasing the speed or size of the pump to meet the flow capacity of the existing wastewater treatment.

In some cases, the functionality or management of the heat recovery system can be automatically integrated to the management software of the wastewater treatment system, e.g., supervisory control and data acquisition (“SCADA”) system. The software may allow an operator to set up heat exchanger configurations, view the real-time status of both the heat recovery system and the WWTP (wastewater treatment plant), and control the systems.

In some embodiments, the software may provide an operator interface allowing an operator to configure the heat exchanger system at set up and/or modify the configuration of the heat exchanger system during operation. The control algorithms may be executed to control the pump of the heat recovery system, the valve of the wastewater treatment system and other components of the system for safety, heat recovery efficiency, and/or cost reduction purposes as described elsewhere herein. Alternatively or additionally, the operator may configure the heat recovery system by setting up a system parameter directly (e.g., flow rate or pump speed).

In some embodiments, the integrated system herein may provide an operator interface to allow an operator to access real-time status and data about the system. For example, data collected from the wastewater treatment and heat recovery system may be displayed on a control panel. The real-time information may allow operators to track heat recovery and other system statistics.

In some cases, the software may be capable of delivering alarms in real-time (e.g., system malfunction, pump shut down, low water level in the tank, etc.). In some cases, the operator interface provided by the system may allow an operator to customize the rule for triggering an alarm. For example, an operator may set up the threshold to trigger an alarm, the frequency of reminders/alarms, and/or the delivery channel for the alarm (e.g., messages, email, in-app message, etc.).

In some cases, the operator interface may comprise a control panel allowing an operator to control at least a portion of the operating parameters. For example, an operator may be able to manually shut down the heat recovery system through the control panel if there is little heat available for recovery or if the system requires maintenance.

In some embodiments, the software may provide a customer interface. A customer may be an individual or corporation that utilizes a wastewater heat recovery system. For example, a customer may be the owner of an apartment building with a wastewater heat recovery installed therein. A customer may be a university, and the university may utilize a wastewater heat recovery system to recover heat from wastewater throughout the university campus. A customer interface may allow a customer to view certain operating or performance statistics. In some cases, a customer interface displays the amount of heat or energy recovered from a wastewater heat recovery system. A customer interface may display the cost savings associated with the installation and operation of a wastewater heat recovery system. A customer interface may display data in real-time or as an average over a given period of time. In some cases, a customer cannot modify operating parameters through the customer interface.

For example, the control panel may be a customer-facing dashboard displaying real-time status of the system and/or provide a customer with a summary of how the system is operating. In some cases, the customer-facing dashboard may comprise reporting function. In some cases, only authorized user(s) may be allowed to edit process parameters via the dashboard.

In some embodiments, the integrated wastewater treatment and heat recovery system is fully automated. The process control system can be fully automated though control and can be manually overridden by a system operator. For example, an operator may be permitted to control the system through a supervisory control and data acquisition (“SCADA”) system to force pumps on/off, adjust pump speed, change control valve opening percentage and various other operations of the system. The operator can return the entire system or individual components to automatic operation at any time. For troubleshooting purposes, an in-line sensor can be manually set to a specific value. This beneficially allows replacing an instrument without interrupting the operation of the system. Additionally, this functionality can be used to diagnose if the automatic functionality is working.

In some embodiments, the heat recovery system and/or the WWTP may be in communication with a remote cloud through the gateway, building's internet service or via cellular network. For example, the gateways may connect to a wide area network (e.g., Internet) or cloud using any TCP/IP or UDP-based capable backhaul, such as Ethernet, Wi-Fi or cellular. The gateways may contain a radio frontend capable of listening to several MHz of RF wireless spectrum at a time, and/or configured to hear all network traffic transmitted within that spectrum. In some cases, the gateways may use synchronized frequency hopping schemes.

In some cases, the user interface may be provided as cloud applications such as a management console or analytics portal that can be accessed by a user, an operator, managers, auditors or third-party entities.

In some cases, the graphical user interface (GUI) or user interface provided by system herein may be rendered on a display of a user device. The display may or may not be a touchscreen. The display may be a light-emitting diode (LED) screen, organic light-emitting diode (OLED) screen, liquid crystal display (LCD) screen, plasma screen, or any other type of screen. The display may be configured to show a user interface (UI) or a graphical user interface (GUI) rendered through a mobile application or cloud application (e.g., via an application programming interface (API) executed on the user device). Similarly, a GUI may also be provided by a local computing system and the GUI may be provided on a display of the wearable device, personnel device, user device at the building. The GUI may be rendered through an application (e.g., via an application programming interface (API) executed on the user device. The user device may be a computing device configured to perform one or more operations consistent with the disclosed embodiments. Examples of user devices may include, but are not limited to, mobile devices, smartphones/cellphones, tablets, personal digital assistants (PDAs), laptop or notebook computers, desktop computers, virtual reality systems, augmented reality systems, microphones, or any electronic device.

The controller, the process control system and various other methods herein may be implemented in hardware, software or a combination of both. In some embodiments, the controller or the process control system may comprise one or more processors such as a programmable processor (e.g., a central processing unit (CPU), a graphic processing unit (GPU), a general-purpose processing unit or a microcontroller), in the form of fine-grained spatial architectures such as a field programmable gate array (FPGA), a digital signal processor (DSP), an application-specific integrated circuit (ASIC), and/or one or more Advanced RISC Machine (ARM) processors. In some embodiments, the processor may be a processing unit of a computer system.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic controller (PLC) device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the systems, media, devices, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages such as PLC ladder logic code.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands. Various functionalities, methods, control algorithms as described herein can be implemented in an application platform, in software, hardware or any combination of the above.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Example 1: Energy Recovery From 30,000 Gallons per Day of Wastewater

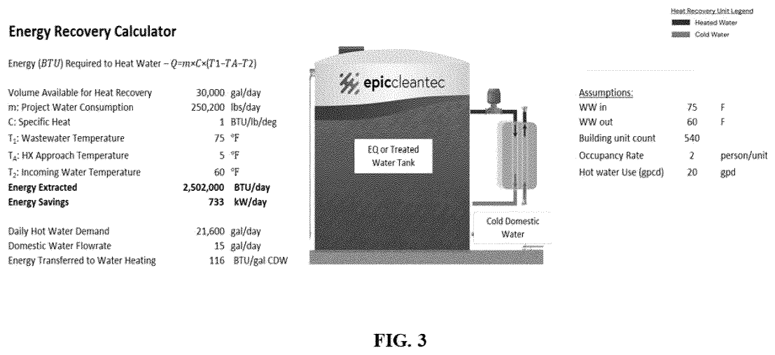

The heat recovery system herein may reduce the cost without compromising the performance. As illustrated in FIG. 3, an apartment building may have about 30,000 gallons per day of wastewater available for heat recovery. Hot water used for showers, cooking, cleaning, washing clothes, etc. may elevate the temperature of the wastewater stream. The temperature of the wastewater may be about 75° F. The 30,000 gallons/day of wastewater may flow to the basement of the apartment building and enter a wastewater treatment and heat recovery process. Thermal energy stored in the warm wastewater may be recovered and used to heat domestic water to be used in the apartment building. The amount of energy available for extraction from the wastewater stream can be calculated using the equation Q=m×C×(T₁−T_{A}−T₂), where Q is the heat energy, m is the mass flow rate of wastewater (250,200 lbs/day), C is the specific heat of water (1 BTU/lb/° F.), T₁ is the input temperature of the wastewater stream (75° F.), T_{A} is the heat exchanger approach temperature of 5° F., and T₂ is the input temperature of the domestic water. Assuming the input temperature of the domestic water (T₂) is 60° F., the energy available for extraction from the wastewater stream is 2,502,000 BTU/day or 733 kWh/day. Assuming hot water demand of 20 gallons per capita per day, an apartment building with 540 units and 2 people/unit may have a total hot water demand of 21,600 gallons/day. Therefore, the energy recovered from the wastewater can provide 116 BTU/gallon to heat domestic water.

### Example 2: Energy Recovery From 37,000 Gallons per Day of Wastewater

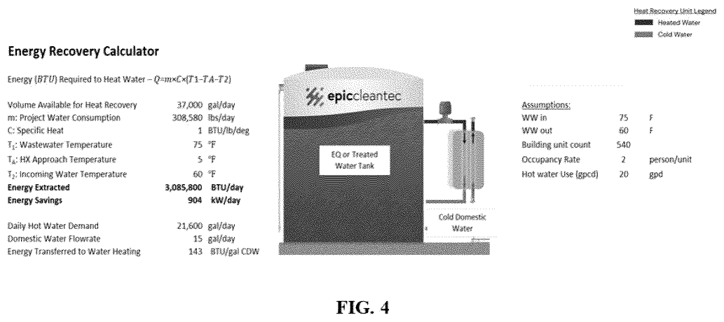

As illustrated in FIG. 4, an apartment building may have about 37,000 gallons per day of wastewater available for heat recovery. Hot water used for showers, cooking, cleaning, washing clothes, etc. may elevate the temperature of the wastewater stream. The temperature of the wastewater may be about 75° F. The 37,000 gallons/day of wastewater may flow to the basement of the apartment building and enter a wastewater treatment and heat recovery process. Thermal energy stored in the warm wastewater may be recovered and used to heat domestic water to be used in the apartment building. The amount of energy available for extraction from the wastewater stream can be calculated using the equation Q=m×C×(T₁−T_{A}−T₂), where Q is the heat energy, m is the mass flow rate of wastewater (308,580 lbs/day), C is the specific heat of water (1 BTU/lb/° F.), T₁ is the input temperature of the wastewater stream (75° F.), T_{A} is the heat exchanger approach temperature of 5° F., and T₂ is the input temperature of the domestic water. Assuming the input temperature of the domestic water (T₂) is 60° F., the energy available for extraction from the wastewater stream is 3,085,800 BTU/day or 904 kWh/day. Assuming hot water demand of 20 gallons per capita per day, an apartment building with 540 units and 2 people/unit may have a total hot water demand of 21,600 gallons/day. Therefore, the energy recovered from the wastewater can provide 143 BTU/gallon to heat domestic water.

### Example 3: Energy Recovery From 50,000 Gallons per Day of Wastewater

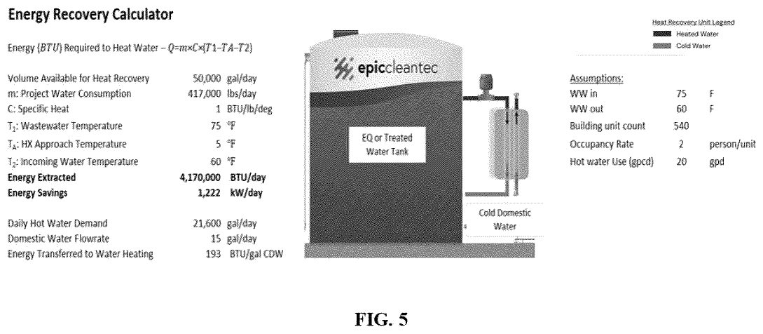

As illustrated in FIG. 5, an apartment building may have about 50,000 gallons per day of wastewater available for heat recovery. Hot water used for showers, cooking, cleaning, washing clothes, etc. may elevate the temperature of the wastewater stream. The temperature of the wastewater may be about 75° F. The 50,000 gallons/day of wastewater may flow to the basement of the apartment building and enter a wastewater treatment and heat recovery process. Thermal energy stored in the warm wastewater may be recovered and used to heat domestic water to be used in the apartment building. The amount of energy available for extraction from the wastewater stream can be calculated using the equation Q=m×C×(T₁−T_{A}−T₂), where Q is the heat energy, m is the mass flow rate of wastewater (417,000 lbs/day), C is the specific heat of water (1 BTU/lb/° F.), T₁ is the input temperature of the wastewater stream (75° F.), T_{A} is the heat exchanger approach temperature of 5° F., and T₂ is the input temperature of the domestic water. Assuming the input temperature of the domestic water (T₂) is 60° F., the energy available for extraction from the wastewater stream is 4,170,000 BTU/day or 1,222 kWh/day. Assuming hot water demand of 20 gallons per capita per day, an apartment building with 540 units and 2 people/unit may have a total hot water demand of 21,600 gallons/day. Therefore, the energy recovered from the wastewater can provide 193 BTU/gallon to heat domestic water.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A heat recovery system, the system comprising:
(i) a heat exchanger that is configured to heat water with thermal energy recovered from a wastewater stream, wherein the wastewater stream is treated by a wastewater treatment system that is in fluidic communication with the heat recovery system, and
(ii) a device configured to control a flow rate of wastewater from the wastewater stream in the heat recovery system based at least in part on real-time sensor data, wherein the device is configured to control the flow rate of the wastewater through the heat recovery system based at least in part on demand for heated water.

2. The heat recovery system of claim 1, wherein the wastewater is at least partially treated by the wastewater treatment system prior to entering the heat recovery system.

3. The heat recovery system of claim 2, wherein the heat exchanger comprises a plate and frame heat exchanger.

4. The heat recovery system of claim 1, wherein the wastewater is treated by the wastewater treatment system after exiting the heat recovery system.

5. The heat recovery system of claim 4, wherein the heat exchanger comprises a shell and tube heat exchanger.

6. The heat recovery system of claim 1, wherein the heat recovery system further comprises a screening system.

7. The heat recovery system of claim 1, wherein the device is configured to control the flow rate of the wastewater based at least in part on a temperature of the wastewater.

8. The heat recovery system of claim 7, wherein the device is configured to increase the flow rate of the wastewater when the temperature of the wastewater is above a threshold value.

9. The heat recovery system of claim 7, wherein the device is configured to decrease the flow rate of the wastewater when the temperature of the wastewater is below a threshold value.

10. The heat recovery system of claim 1, wherein the device is configured to increase the flow rate of the wastewater through the heat recovery system when the demand for the heated water is above a threshold value.

11. The heat recovery system of claim 1, wherein the device is configured to decrease the flow rate of the wastewater through the heat recovery system when the demand for the heated water is below a threshold value.

12. The heat recovery system of claim 1, wherein the heat recovery system further comprises a wastewater holding tank.

13. The heat recovery system of claim 12, wherein the device is configured to control the flow rate of the wastewater based at least in part on an amount of wastewater present in the wastewater holding tank.

14. The heat recovery system of claim 12, wherein the device is configured to shut off when an amount of wastewater present in the wastewater holding tank is below a threshold level.

15. The heat recovery system of claim 1, wherein the heat recovery system is contained within a complete skid mounted system.

16. The heat recovery system of claim 15, wherein the complete skid mounted system is configured to be coupled to an existing wastewater treatment system.

17. The heat recovery system of claim 1, wherein the heat recovery system is located at a location that is within a source of the wastewater stream.

18. The heat recovery system of claim 17, wherein the source is a building.

19. The heat recovery system of claim 18, wherein the heat recovery system is located in a basement of the building.

20. The heat recovery system of claim 1, wherein at least a portion of the wastewater used by the heat recovery system is not fully treated by the wastewater treatment system.

21. The heat recovery system of claim 1, wherein the device is a pump.

22. The heat recovery system of claim 1, wherein the device is a valve.

23. The heat recovery system of claim 1, wherein a source of the wastewater stream is a building, and wherein the heat recovery system is located outside of the building.

24. The heat recovery system of claim 1, wherein the heat recovery system is located off-site from a source of the wastewater stream.
